(19) United States
(12) Patent Application Publication
(10) Pub. No.: US 2020/0311601 A1
(43) Pub. Date: Oct. 1, 2020

(54) HYBRID RULE-BASED AND MACHINE LEARNING PREDICTIONS

(71) Applicant: Optum, Inc., Minnetonka, MN (US)

(72) Inventors: Jason R. Robinson, San Diego, CA (US); Ellyn J. Oliver, San Diego, CA (US); Rebecca J. Myhre, San Diego, CA (US); Mingyang Xu, San Diego, CA (US)

(21) Appl. No.: 16/370,115

(22) Filed: Mar. 29, 2019

(51) Int. Cl. G06N 20/00; G06N 3/04; G06N 3/08

(52) U.S. Cl. CPC G06N 20/00; G06N 3/084; G06N 3/04

(57) ABSTRACT

A computer-implemented method for generating a predictive output based on a predictive input includes generating a plurality of rule-based prediction scores by executing one or more prediction rules on the prediction input, wherein each prediction rule of the one or more prediction rules is associated with a rule condition and one or more predictive weights, each predictive weight of the one or more predictive weights is associated with a related prediction category of a plurality of prediction categories, and each prediction category of the plurality of prediction categories is associated with a rule-based prediction score; determining a rule-based prediction output based at least in part on the plurality of rule-based prediction scores; and providing the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

### BACKGROUND

Many existing predictive systems that utilize machine learning models suffer from accuracy and/or efficiency drawbacks that result from differences between training data used to train machine learning models and input data used by those models to make predictive inferences. For example, many existing machine learning solutions need to be trained on already existent data which may have a structure that is statically defined. Once a machine learning model is produced, such a model may be static and only reflective of the data on which it was trained. Such static models, which use statically-defined input data to generate static predictions and static confidence values for those predictions, often fail to generate sufficiently accurate prediction when presented with data that has features different from the training data and/or has a structure that is different from the training data.

### BRIEF SUMMARY

In general, embodiments of the present invention provide methods, apparatus, systems, computing devices, computing entities, and/or the like.

In accordance with one aspect, a method is provided. In one embodiment, the method comprises receiving a prediction input; generating a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score; determining a rule-based prediction output based at least in part on the plurality of rule-based prediction scores; and providing the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

In accordance with another aspect, a computer program product is provided. The computer program product may comprise at least one computer-readable storage medium having computer-readable program code portions stored therein, the computer-readable program code portions comprising executable portions configured to receive a prediction input; generate a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score; determine a rule-based prediction output based at least in part on the plurality of rule-based prediction scores; and provide the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

In accordance with yet another aspect, an apparatus comprising at least one processor and at least one memory including computer program code is provided. In one embodiment, the at least one memory and the computer program code may be configured to, with the processor, cause the apparatus to receive a prediction input; generate a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score; determine a rule-based prediction output based at least in part on the plurality of rule-based prediction scores; and provide the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an exemplary overview of an architecture that can be used to practice embodiments of the present invention.

FIG. 2 illustrates an example prediction computing entity in accordance with some embodiments discussed herein.

FIG. 3 illustrates an example external computing entity in accordance with some embodiments discussed herein.

FIG. 4 depicts a flowchart diagram of an example process for performing a prediction in accordance with some embodiments discussed herein.

FIG. 5 depicts a data flow diagram of an example process for generating predictive outputs using a rules engine in accordance with some embodiments discussed herein.

FIG. 6 depicts a data flow diagram of an example process for generating predictive outputs using a machine learning engine in accordance with some embodiments discussed herein.

FIG. 7 depicts a data flow diagram of an example process for generating predictive outputs using both a rules engine and a machine learning engine in accordance with some embodiments discussed herein.

FIG. 8 provides an operational example of a text prediction input in accordance with some embodiments discussed herein.

FIG. 9 provides an operational example of a prediction rules repository in accordance with some embodiments discussed herein.

FIG. 10 provides an operational example of a per-category prediction score table in accordance with some embodiments discussed herein.

FIG. 11 depicts a flowchart diagram of an example process for generating a rule-based prediction in accordance with some embodiments discussed herein.

FIG. 12 depicts a flowchart diagram of an example process for training a machine learning engine to generate predictive outputs by integrating rule-based predictive data in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

The architecture 100 is configured to generate a prediction output based on a prediction input. For example, the prediction input may include data characterizing a visual data object and the prediction output may identify an estimated shape for the prediction input. As another example, the prediction input may include data characterizing a text string (e.g., a text string associated with a digital document) and the prediction output may identify an estimated subject matter for the prediction input. The architecture 100 includes one or more external computing entities configured to provide prediction inputs (e.g., generated based on user input received from an user) to the prediction system 101 and receive corresponding prediction outputs for the prediction system 101, as well as a prediction system 101 configured to process the prediction inputs to generate corresponding prediction outputs. The external computing entities 102 may also be configured to provide prediction rules to the prediction system 101.

The architecture 100 may further include one or more communication networks, where a communication network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the architecture may include a communication network for communication between the prediction system 101 and each external computing entity 102. Each computing entity, computing system, and/or computing resource in the architecture 100 may include one or more of any suitable network server and/or other type of processing device.

The prediction system 101 includes a prediction computing entity 106 and a storage subsystem 108. The prediction computing entity 106 is configured to train one or more machine learning models based on data in the storage subsystem 108, store trained machine learning models in the storage subsystem 108, receive prediction inputs, and process prediction inputs using trained machine learning models and prediction rules stored in the storage subsystem 108 to generate corresponding prediction outputs. Accordingly, the storage subsystem 108 includes a training database 121 configured to store training data used by the prediction computing entity 106 to train machine learning models, a parameters database 122 configured to store trained machine learning models generated by the prediction computing entity 106, and a rules database 123 configured to store prediction rules used by the prediction computing entity 106.

The storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. In some embodiments, the storage subsystem 108 may be configured to store one or more relational databases, such as one or more MySQL databases. In some embodiments, the storage subsystem 108 may be configured to store one or more non-relational databases, such as one or more JSON databases or one or more NOSQL databases. In some embodiments, Each database in the storage subsystem 108 (e.g., at least one of the training database 121, the parameters database 122, and the rules database 123) is configured to store data using at least one data model, such as a relational data model, an object-oriented data model, and/or a non-related data model, such a so-called “unstructured” data model (e.g., XML model, JSON model, etc.).

The prediction computing entity 106 includes a rules engine 115, a training engine 116, a machine learning engine 117. The rules engine 115 is configured to process the prediction input using one or more prediction rules stored in the rules database 123 to generate a rule-based prediction and one or more rule-based prediction scores. The rules engine 115 is also configured to provide the generated rule-based prediction and rule-based prediction scores to the machine learning engine 117. The rules engine 115 may also be configured to generate prediction rules (e.g., based on user input, for example user input received from an external computing entity, and/or by performing an automatic rule generation process) and store the generated prediction rules in the rules database 123.

The training engine 116 is configured to utilize at least one training algorithm to train and/or re-train one or more machine learning model based on training data in the training database 121. For example, to train a machine learning model, a training engine may retrieve a prediction input from training data, provide the prediction input to the machine learning model, receive an output classification generated by the machine learning model after processing the prediction input, retrieve a ground-truth classification for the prediction input from the training data, compare the output classification and the ground-truth classification to generate an error measure for the machine learning model, and set the parameters of the machine learning model based on the error measure. An example of a training algorithm is gradient-descent, e.g., gradient descent with backpropagation or gradient descent with backpropagation through time. The training engine 116 is also configured store resulting trained machine learning models in the parameters database 122 of the storage subsystem 108.

The machine learning engine 117 is configured to obtain the prediction input, receive the rule-based prediction and the rule-based prediction scores from the rules engine 115, process the prediction input, the rule-based prediction, and the rule-based prediction scores to generate one or more prediction outputs (e.g., a classification, n prediction categories having the highest prediction scores, the machine learning classification along with the rule-based prediction, etc.). For example, the machine learning engine 117 may be configured to process using the prediction input and the rule-based prediction scores using trained machine learning models retrieved from the parameters database 122 to generate a classification, and process the generated classification along with the rule-based prediction to generate a prediction output. In some embodiments, the machine learning engine 117 may be configured to perform a prediction algorithm using a multi-processor computer and by utilizing parallel computing. The machine learning engine 117 may also be configured to provide the generated prediction output to an external computing entity 102.

### A. Exemplary Prediction Computing Entity

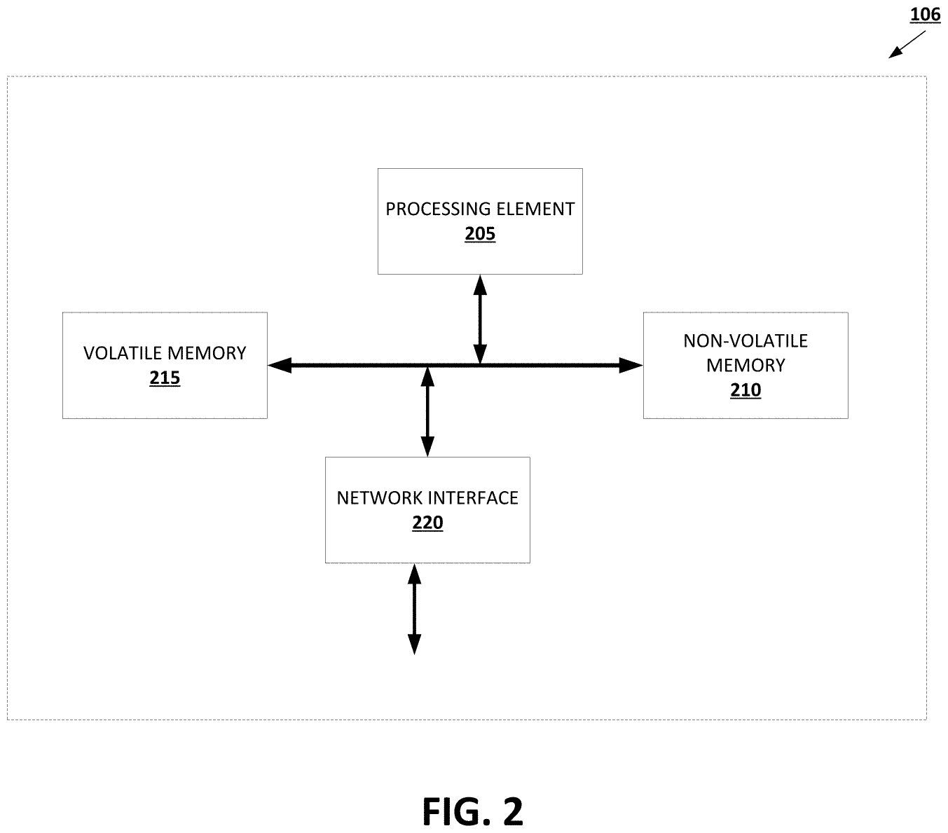

FIG. 2 provides a schematic of a prediction computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the prediction computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the prediction computing entity 106 may include or be in communication with one or more processing elements 205 (also referred to as processors, processing circuitry, and/or similar terms used herein interchangeably) that communicate with other elements within the prediction computing entity 106 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the prediction computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, object model, semantic model, graph model, and/or the like.

In one embodiment, the prediction computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the prediction computing entity 106 with the assistance of the processing element 205 and operating system.

As indicated, in one embodiment, the prediction computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the prediction computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the prediction computing entity 106 may include or be in communication with one or more input elements, such as a keyboard input, a mouse input, a touch screen/display input, motion input, movement input, audio input, pointing device input, joystick input, keypad input, and/or the like. The prediction computing entity 106 may also include or be in communication with one or more output elements (not shown), such as audio output, video output, screen/display output, motion output, movement output, and/or the like.

As will be appreciated, one or more of the management computing entity's 100 components may be located remotely from other prediction computing entity 106 components, such as in a distributed system. Furthermore, one or more of the components may be combined and additional components performing functions described herein may be included in the prediction computing entity 106. Thus, the prediction computing entity 106 can be adapted to accommodate a variety of needs and circumstances. As will be recognized, these architectures and descriptions are provided for exemplary purposes only and are not limiting to the various embodiments.

### B. Exemplary External Computing Entity

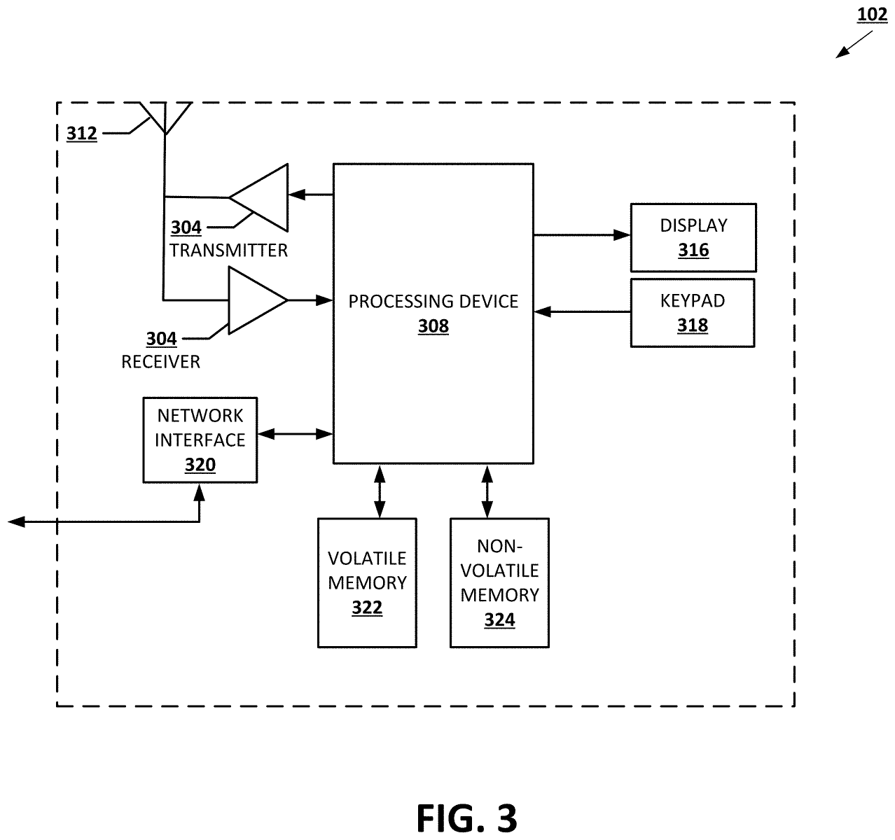

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the prediction computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the prediction computing entity 106 via a network interface 320.

Via these communication standards and protocols, the external computing entity 102 can communicate with various other entities using concepts such as Unstructured Supplementary Service Data (US SD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the user computing entity's 121 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information from the prediction computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the prediction computing entity 106 and/or various other computing entities.

In another embodiment, the external computing entity 102 may include one or more components or functionality that are the same or similar to those of the prediction computing entity 106, as described in greater detail above. As will be recognized, these architectures and descriptions are provided for exemplary purposes only and are not limiting to the various embodiments.

### III. EXEMPLARY SYSTEM OPERATION

The operation of various embodiments of the present invention will now be described. As discussed herein, various embodiments are directed to methods, apparatus, systems, computing devices, computing entities, and/or the like for performing predictive inferences using both trained machine learning models and predictive rules, e.g., predictive rules that can be modified after training of the machine learning model.

### A. Definitions of Exemplary Terms

As used herein, the terms “machine learning algorithm” or “training algorithm” refer to a computer-implemented process that produce a machine learning model configured to generate a classification based on a prediction input. For example, a machine learning algorithm or a training algorithm may produce a machine learning model configured to generate a classification of a visual data object characterized by a height measurement for the visual data object and a width measurement for the data object as a square object or a rectangular object based on the height measurement and the width measurement. An example of a machine learning algorithm or a training algorithm is the gradient-descent algorithm, e.g., gradient descent with backpropagation or gradient descent with backpropagation through time.

The term “deep learning” may refer to a machine learning task performed by using at least one artificial neural network. For example, a deep learning framework may utilize at least one of a feedforward neural network, a convolutional neural network, and a recurrent neural network to generate a classification based on a prediction input.

The term “machine learning model” may refer to a combination of one or more parameter values that, when applied to a prediction input according to one or more predefined numerical operations, generate a classification for the prediction input. For example, a machine learning model for an artificial neural network may define parameters for each deep learning node of the artificial neural network, such as weights applied to inputs of the deep learning nodes in order to generate weighed inputs as well as biases applied to combinations of weighed inputs for each deep learning node.

The term “training a machine learning model” may refer to a computer-implemented process for determining values for one or more parameters characterizing a machine learning model based on training data. For example, to train a machine learning model, a training engine may retrieve a prediction input from training data, provide the prediction input to the machine learning model, receive an output classification generated by the machine learning model after processing the prediction input, retrieve a ground-truth classification for the prediction input from the training data, compare the output classification and the ground-truth classification to generate an error measure for the machine learning model, and set the parameters of the machine learning model based on the error measure.

The term “retraining a machine learning model” may refer to a computer-implemented process for training a machine learning model after an earlier training of the machine learning model. For example, a training engine may retrain a machine learning model using training data that is different from (e.g., includes training data in addition to) the training data used for the earlier training of the machine learning model. As another example, a training engine may retrain a machine learning model to determine a set of parameter values for the machine learning model that is different from (e.g., includes parameters in addition to) a set of parameter values determined during the earlier training of the machine learning model.

The term “prediction algorithm” may refer to a computer-implemented processes that processes a prediction input in accordance with a machine learning model and one or more numerical operations to generate a classification for the prediction input. For example, a prediction algorithm may supply each data item in the prediction input to a respective deep learning node of an input layer of an artificial neural network, where each deep learning node is configured to process the prediction input in accordance with a set of parameter values for the deep learning node in order to generate a respective output for each deep learning node in a subsequent layer of the artificial neural network. The layer-by-layer approach may continue until each deep learning node in an output layer of the artificial neural network generates a prediction score describing a likelihood that the prediction input corresponds to each of various prediction categories associated with the deep learning node in the output layer.

The term “classification” may refer to a data object that identifies a prediction generated by performing a prediction algorithm based on a prediction input. For example, a machine learning engine may perform a prediction algorithm to generate a square or rectangular classification for a prediction input. The machine learning engine may select the classification from one or more prediction categories (e.g., a “square” prediction category and a “rectangle” prediction category) based on the prediction scores for the one or more prediction categories generated by the performing the prediction algorithm based on the prediction input. Terms such as category, label, and/or the like are used herein interchangeably.

The term “text classification” may refer to a data object that identifies a prediction generated by performing a prediction algorithm based on a prediction input, where the prediction input is associated with a text data object. For example, the text data object may include a digital document and the text classification for the digital document may identify the digital document as having a subject category (e.g., a discharge summary summary) from a plurality of possible subject categories.

The terms “user” and “end user” refer to a user profile (e.g., corresponding to a person or entity) that provides a prediction input to a computer entity configured to perform the prediction algorithm and requests that the computer entity provides a classification for the prediction entity. For example, the end user may be a user profile that provides a visual-object prediction input (e.g., a visual data object and/or measurements for a visual data object) and request a classification of the visual-object prediction input as a square object or a rectangular object. As another example, the end user may be a user profile that provides a text prediction input (e.g., a text string and/or information about features of a text string) and requests a classification of the text prediction input as sports-related, politics-related, etc. An example of a user is a subject matter expert (SME) user, e.g., an SME user who may expect a requisite level of traceability for a prediction system based on real-world logic.

The term “prediction rule” may refer to a data object that identifies a rule condition as well as one or more predictive weights each associated with a prediction category, where the rule condition is a binary condition whose satisfaction in relation to a prediction input indicates that the prediction input corresponds to each prediction category associated with a predictive weight with a prediction score specified by the predictive weight. For example, a prediction rule may specify that “If the term ‘Michael Jordan’ appears in a text prediction input, the text prediction input is 90% sports-related and 30% society related,” where the rule condition for the prediction rule is presence of the term “Michael Jordan” in a text prediction input and the predictive weights for the prediction rule include a 90% predictive weight associated with a sports-related prediction category and 30% predictive weight associated with a society-related prediction category.

The term “rules engine” may refer to a computer-implemented process that processes a prediction input in accordance with one or more prediction rules to generate a rule-based prediction and one or more rule-based prediction scores. For example, a rules engine may process a text prediction input to indicate that the text is 40% sports-related, 20% society-related, 20% politics-related, and 10% science-related, and may thus conclude that the rule-based prediction for the text input is a sports-related classification and the rule-based prediction scores for the text input correspond to the following rule-based prediction vector: [SPORTS=0.40, SOCIETY=0.20, POLITICS=0.20, SCIENCE=0.10].

The term “rule-based classification” may refer to a data object that identifies a prediction generated by performing operations associated with a rules engine based on a prediction input, for example, based on a plurality of rule-based prediction scores for a plurality of prediction categories. The rule-based prediction may be integrated with a classification to generate a prediction output.

The term “rule-based prediction scores” may refer to a data object that identifies one or more confidence scores each denoting a likelihood that a prediction input corresponds to a respective prediction category, where each confidence score is generated by applying one or more prediction rules to the prediction input. For example, the data object corresponding to the rule-based prediction scores may be a vector that includes a plurality of confidence scores each associated with a prediction category of a plurality of prediction categories.

### B. Brief Overview of Technical Problems

Various embodiments of the present invention address technical problems related to degradations in accuracy of machine learning systems resulting from differences between training data used to train machine learning models and input data used by those models to make predictive inferences. For example, many existing machine learning solutions need to be trained on already existent data which may have a structure that is statically defined. Once a machine learning model is produced, such a model may be static and only reflective of the data on which it was trained. Such static models, which use statically-defined input data to generate static predictions and static confidence values for those predictions, often fail to generate sufficiently accurate prediction when presented with data that has features different from the training data and/or has a structure that is different from the training data.

Because of the static properties of many existing machine learning models, post-training modifications in structure of data and/or discoveries about new features of data may undermine accuracy of machine learning models. After training, it may be discovered that particular features are very helpful in discovering classifications of input objects, but because such features were not known at training time, they cannot be integrated into existing machine learning solutions. One version of this problem, called the problem of overfitting which relates to the objective of producing machine learning models better adapted to generalize to diverse input data, is one of the biggest problems in machine learning technology. Other versions of this problem relate to post-training discoveries about input features which may severely impact effectiveness and/or efficiency of machine learning models used to perform predictive tasks.

Conventional solutions to the above-noted problems, e.g., the problems resulting from differences between training data used to train machine learning models and input data used by those models to make predictive inferences, rely on collecting more training data and retraining the machine learning using the larger set of training data. According to those solutions, as more data is collected, the machine learning model should be retrained to capture any new phenomena that might be present in the more recent data but not the original training data or to capture predictive significance of newly discovered features in input data. However, retraining a model is often computationally expensive and time-consuming, efficiency-degrading factors that may increase as the complexity of a machine learning model increases and/or as the size of the training data corpus increases. Therefore, conventional solutions fail to provide computationally efficient solutions for addressing the technical problems related to degradations in accuracy of machine learning systems resulting from differences between training data used to train a machine learning model and input data used to make predictive inferences by machine learning systems.

The static and abstract nature of many existing machine learning problems can undermine user belief in machine learning outputs and complicate user ability to integrate machine learning outputs into complex decision-making systems in order to achieve desired utility maximization objectives. This is especially the case in use cases where the utility maximization objectives require a user-defined tradeoff between precision and recall. With respect to those use cases, the user can benefit from a more interpretable output that allows insights into the prediction process. For example, a user utilizing a machine learning model to perform cancer screening might prefer to bias the output of the model in order to output a positive prediction in all of the instances in which the patient indeed has cancer and in half of those cases in which the patient does not have cancer, in order to never miss true positive cases even at the risk of predicting some false positive cases that can be filtered out through more precise and more expensive diagnostic measures. Unless such a bias is statically defined and integrated into the machine learning model at training time, e.g., in the absence of SME verification and/or interpretability of model processes by SMEs, many existing machine learning models cannot integrate such bias post-training without re-training. Because many existing machine learning models can only be updated after training through computationally complex and resource-intensive re-training, the user has little to no control in modifying operation of such models after deployment of such models on user systems.

Moreover, various embodiments of the present invention address technical problems related to interpretability of machine learning outputs. Many existing machine learning models do not produce interpretable answers, a property that can undermine confidence in their predictions as well as jeopardize their utility for users in instances where a tradeoff between precision and recall is required. For example, many existing machine learning models (and almost all deep learning models) produce outputs that consist of a prediction along with a floating point confidence measure. This output, while clear, provides little if any insight to the user about why or how the prediction and/or the confidence measure was obtained. Thus, many existing machine learning models and almost all deep learning models produce outputs that are not very interpretable because the user may have little insight about how those outputs were generated. For example, the user may have little insight about how a confidence measure, typically a numeric value in the range [0, 1] relates to features of input data. Accordingly, while the user may interpret a deep learning model as more or less confident, the end user of has little, if any, insight about why or how that confidence was determined. A similar problem may arise when machine learning models lack an audit trail that is verifiable by others, e.g., SMEs. Often, it would be beneficial if SMEs can follow the audit trail of a machine learning model in order to verify conclusions determined by the model output.

### C. Brief Overview of Technical Solutions

Various embodiments of the present invention address technological problems related to degradations in accuracy of machine learning systems resulting from differences between training data and inference input data by using post-training rules to develop new rule-based features (e.g., rule-based prediction scores and/or rule-based predictions) for the machine learning model. Through enabling such rule-based prediction capabilities and integrating such capabilities with intelligent machine learning models, various embodiments of the present invention allow users (such as SMEs) to create ad-hoc prediction rules ranked by confidence weights for each rule that a prediction algorithm can use as partial input in addition to its other machine learning input features. Because some users, such as SMEs, are generally well-trained and understand the prediction domain intimately, such users are able to specify logical rules that can have high degrees of accuracy and can proper account for post-training discoveries and changes in data. Thus, even after training and deployment of a prediction system, new prediction rules can be manually created and modified by end users to generalize classification capabilities without the need to incur costs associated with re-training the machine learning model. Moreover, the prediction rules may be weighed with user-defined and/or automatically-generated weights which indicates measures of predictive confidence in and/or predictive priority of the respective prediction rules.

By utilizing prediction rules and enabling post-training modification of such prediction rules, various embodiments of the present invention enable modifications in the work of a machine learning model without a need for retraining the machine learning model. In doing so, various embodiments of the present invention address technical problems related to insufficient generalization capabilities of trained machine learning models because of training data limitations. As described above, one of the issues of the machine learning models is that they needs large amount of relevant training data to make accurate predictions, such that when the relevant training data is limited or inference input data is not sufficiently similar to the training data, the machine learning models may suffer. The general knowledge provided by rule-based predictors solve this problem and enable the machine learning models to generate accurate results even when the limited training data is available and/or when inference input data significantly deviates from the training data. In this approach, the features generated by the rule-based predictors are incorporated into the machine learning models to serve as a general knowledge, which gives the machine learning models guidance during training and helps the machine learning models generate more accurate predictions and probabilities post-training. This approach in turn may enable various embodiments of the present invention to perform post-training modifications of rules based on SME guidance, e.g., post-training modifications necessitated by regulatory changes and/or changes in other requirements placed on the machine learning output, post-training modifications in input forms and/or input availability, etc.

In addition, the rule-based prediction itself may provide insights for classifiers in determining a final classification output for a prediction input, thus providing another way for integrating general knowledge, such as SME knowledge, into machine learning operation after training of a machine learning model. Providing rule-based prediction as an output along with machine learning prediction output can provide a secondary prediction that may prove useful and interpretable to the user and/or may be incorporated by the machine learning model when making the final prediction. Importantly, even when the rule-based prediction is different from the machine learning prediction, the proximity of the two predictions can have predictive significance. For example, when a rule-based prediction classifies a digital document as a sports editorial and the machine learning prediction classifies the same digital document as a sports news, the prediction system may infer from the two predictions that the digital document is sports-related. This result can enhance accuracy and produce an interpretable result that can be tracked through interactions of the machine learning model and the various prediction rules. Therefore, in providing these functionalities, various embodiments of the present invention address technical problems related to interpretability of machine learning prediction outputs.

Therefore, various embodiments of the present invention enable various methods for designing, training, and/or utilizing dynamically-defined machine learning models that address and overcome limitations of statistically-defined machine learning models. For example, by integrating one or more “general knowledge inputs” derived from rule-based prediction scores, various embodiments of the present invention integrate dynamically-defined inputs that can be modified through user input after training. As another example, by integrating “best guess classifications” into machine learning models, various embodiments of the present invention enable filtering of machine learning classifications based on rule-based predictions that can be modified post-training, thus enabling users to significantly affect outcomes generated by machine learning models without undermining the structural integrity of those models and compromising their predictive effectiveness. Importantly, because machine learning models are trained using at least some data items determined based on prediction rules, machine learning models may be trained to understand dynamic nature of particular inputs and thus integrate modifiability of such inputs into their prediction models. In other words, machine learning models may be trained to incorporate predictive models that integrate the dynamic nature of feature spaces, thus creating new paradigms for interaction of prediction models and data derived from real-world phenomena.

Moreover, various embodiments of the present invention make results of the machine learning models more interpretable, as the users can better understand the result of application of modifiable prediction rules in comparison to numerous combinations of transformations, e.g., non-linear transformations, characterizing the machine learning models. By manipulating prediction rules, the users can gain insights about the overall predictive processes including the machine learning models utilized by those predictive processes. This in turn enables the users to modify outcomes generated by machine learning models post-training, thus increasing user trust in machine learning models and enhancing capabilities of the machine learning models to contribute to utility maximization objectives. Moreover, by enabling other users (e.g., SMEs) to follow the audit trails of prediction models, various embodiments of the present invention increase reliability of those prediction models by providing a mechanisms for verification of the predictive processes used by those prediction models to determine predictive outputs.

For example, in the cancer screening example noted above, the user may define rules that require a positive prediction if a patient has particular highly predictive features unless the confidence measure for a negative prediction is more than a threshold amount. In this way, the user may gain a better understanding of how the machine learning mode generates confidence measures and can adjust the prediction rules to correct any biases and/or imperfections. Accordingly, by gaining a better understanding of the predictive processes and the machine learning models used by those predictive processes, users of the predictive processes can modify those predictive processes to enhance the predictive utilities provided by such predictive processes without a need to re-train the machine learning models utilized by those predictive processes. This in turn can make predictive processes that utilize machine learning frameworks more adaptable, efficient, and effective.

### D. Hybrid Rule-Based Machine-Learning Predictive Solutions

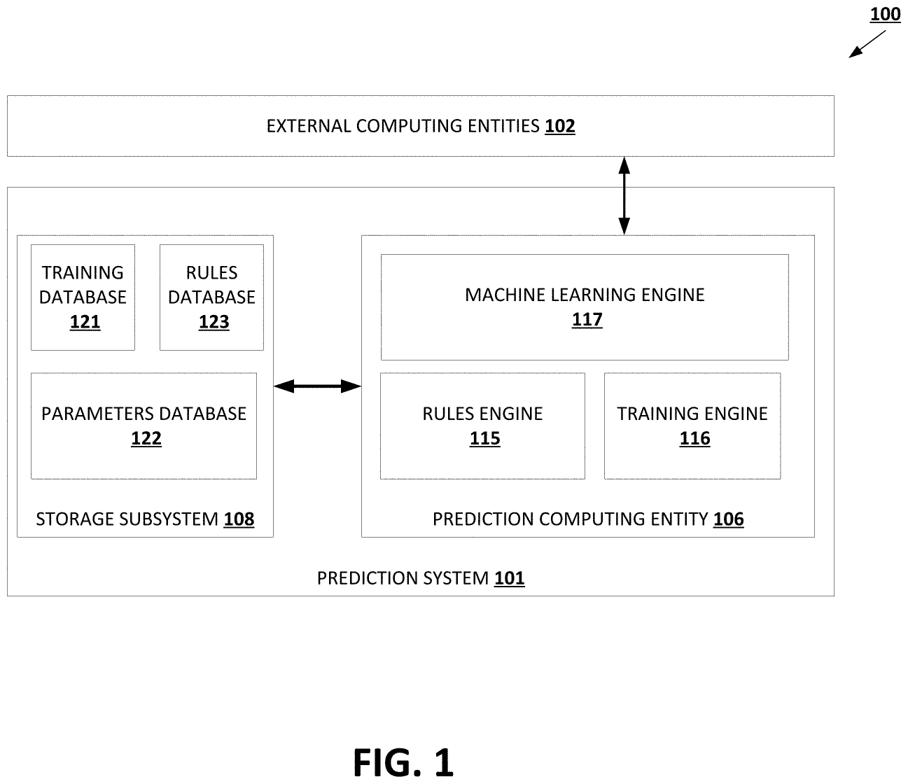

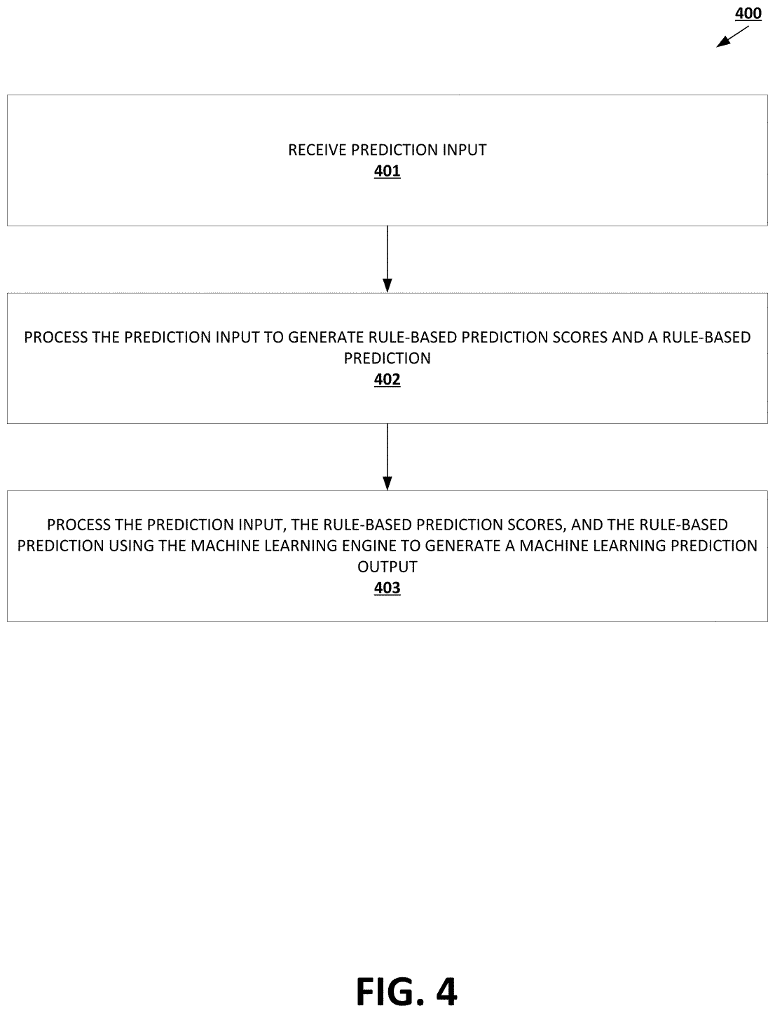

FIG. 4 depicts a flowchart diagram of an example process 400 for performing a prediction based on a prediction input. The various steps/operations of process 400 may be performed by a system of one or more computers, e.g., the prediction system 101 of FIG. 1. Via the various steps/operations of FIG. 4, the prediction system 101 can perform predictive inferences using both trained machine learning models and prediction rules.

The process 400 starts at step/operation 401 when the prediction computing entity 106 receives the prediction input. For example, the machine learning engine 117 of the prediction computing entity 106 may receive a prediction input from a particular external computing entity 102, and the particular external computing entity 102 in turn may generate the prediction input based on a user input provided by at least one end user of the particular external computing entity 102 to the particular external computing entity 102.

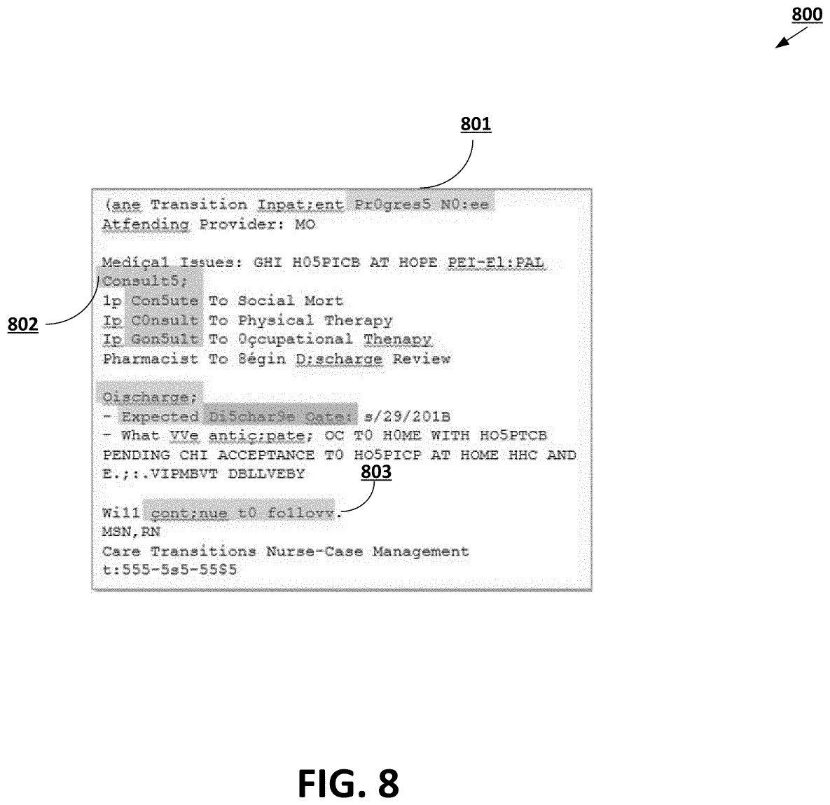

The machine learning engine 117 may store the received prediction input in the storage subsystem 108. The prediction input may, for example, be a text prediction input corresponding to a text string (e.g., a text string for a digital document). FIG. 8 provides an operational example of a text prediction input 800. The text prediction input 800 of FIG. 8 includes various terms, such as term 801 (e.g. “Pr0gres5 N0:ee”), terms 802 (“Consult5,” “Con5ute,” “C0nsult,” and “Gon5ult”), and terms 803 (“cont:nue t0 follovv”). As depicted in the text prediction input 800, the terms of a text prediction input may have inaccuracies, for example inaccuracies because of failures of an optical character recognition (OCR) process.

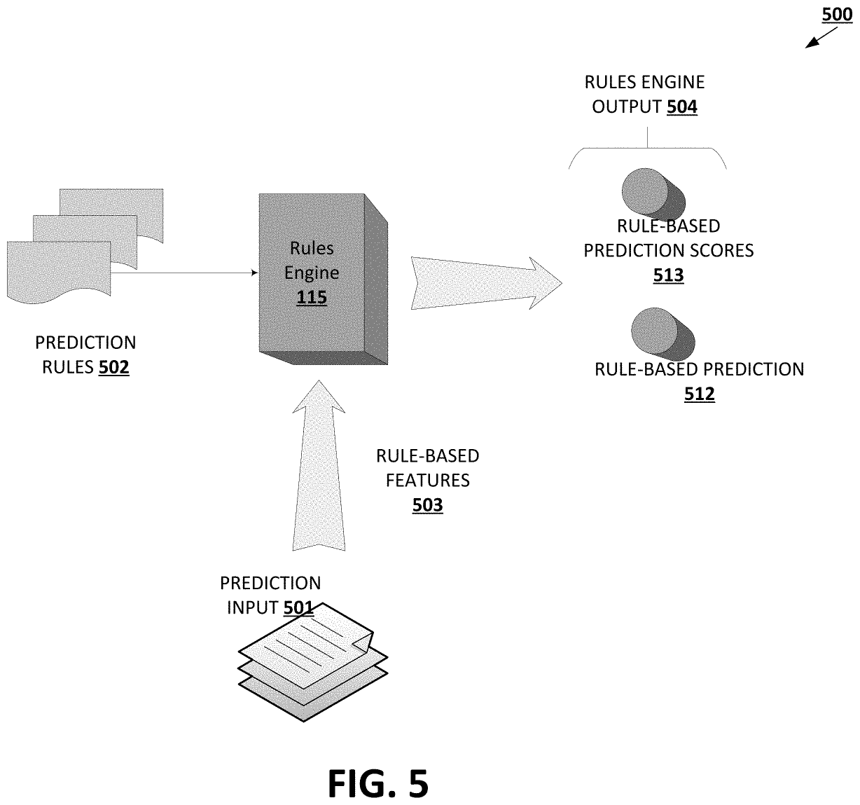

At step/operation 402, the prediction computing entity 106 processes the prediction input using the rules engine 115 to generate one or more rule-based prediction scores and a rule-based prediction scores. In some embodiments, step/operation 402 may be performed in accordance with various steps/operations of process 500 depicted in FIG. 5. As depicted in FIG. 5, to perform the process 500, the rules engine 115 generates one or more rule-based features for the prediction input 501, and process rule-based features 503 and one or more prediction rules 502 to generate a rules engine output 504 that includes a rule-based prediction 512 and one or more rule-based prediction scores 513. In some embodiments, each prediction rule 502 indicates a rule condition as well as one or more predictive weights each associated with a prediction category.

In some embodiments, each prediction rule 502 may be a combination (e.g., a conjunction or disjunction) of one or more condition predicates, where each condition predicate may satisfy satisfactory values for a particular feature of the prediction input 501. Therefore, the rule-based features 503 of the prediction input 501 may be characterized by the features associated with predicates of the prediction rules 502.

In some embodiments, the satisfaction of a predictive rule in relation to a prediction input may indicate association of the prediction input with the prediction categories indicates by the prediction rule in accordance with the predictive weights associated with the prediction rule. The rules engine 115 may aggregate the predictive weights of the prediction rules satisfied by a prediction input to determine rule-based classification scores for the prediction input. The rules engine 115 may further determine the rule-based classification based on the rule-based classification scores.

For example, if the prediction rules 502 include rule R1 whose satisfaction indicates association of the prediction input 501 with prediction category C1 with 90% confidence and prediction category C3 with 30% confidence, rule R2 whose satisfaction indicates association of the prediction input 501 with prediction category C2 with 60% confidence and prediction category C3 with 10% confidence, and rule R3 whose satisfaction indicates association of the prediction input 501 with prediction category C1 with −10% confidence and prediction category C2 with 40% confidence, and if the prediction input 501 satisfies all three prediction rules 502, the rules engine 115 may generate the following rule-based prediction scores 513 for the prediction input 501 based on the following computations: [Prediction Score for C1=0.90+0−0.10=0.80, Prediction Score for C2=0+0.60+0.40=1.00, Prediction Score for C3=0.30+0.10=0.40]. The rules engine 115 may further select a predication category having the highest rule-based prediction score 513 as the rule-based prediction 512.

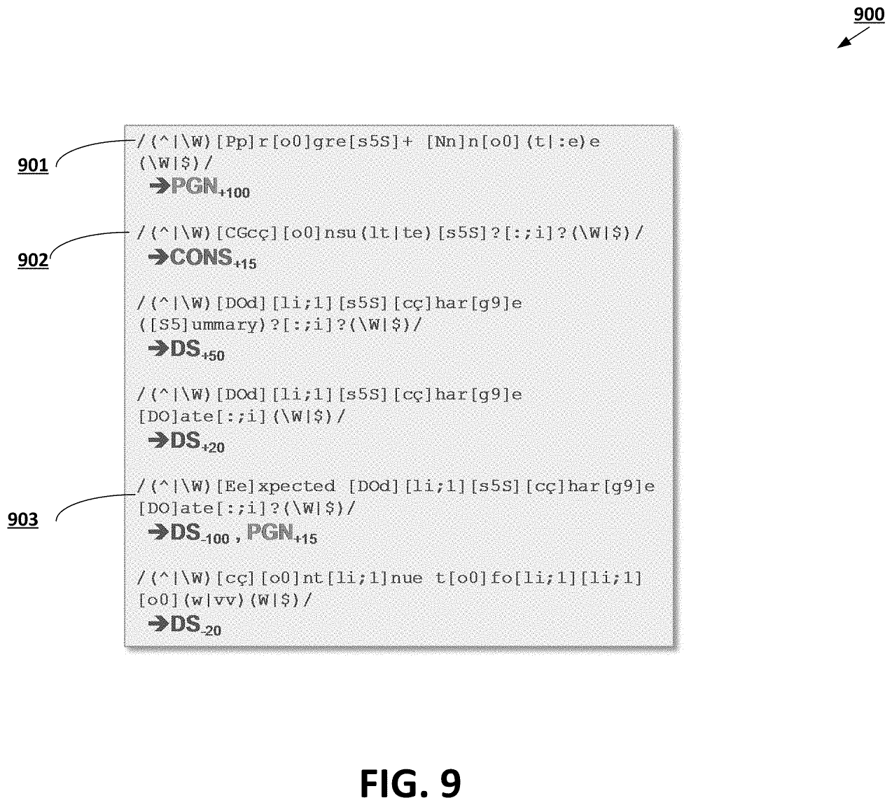

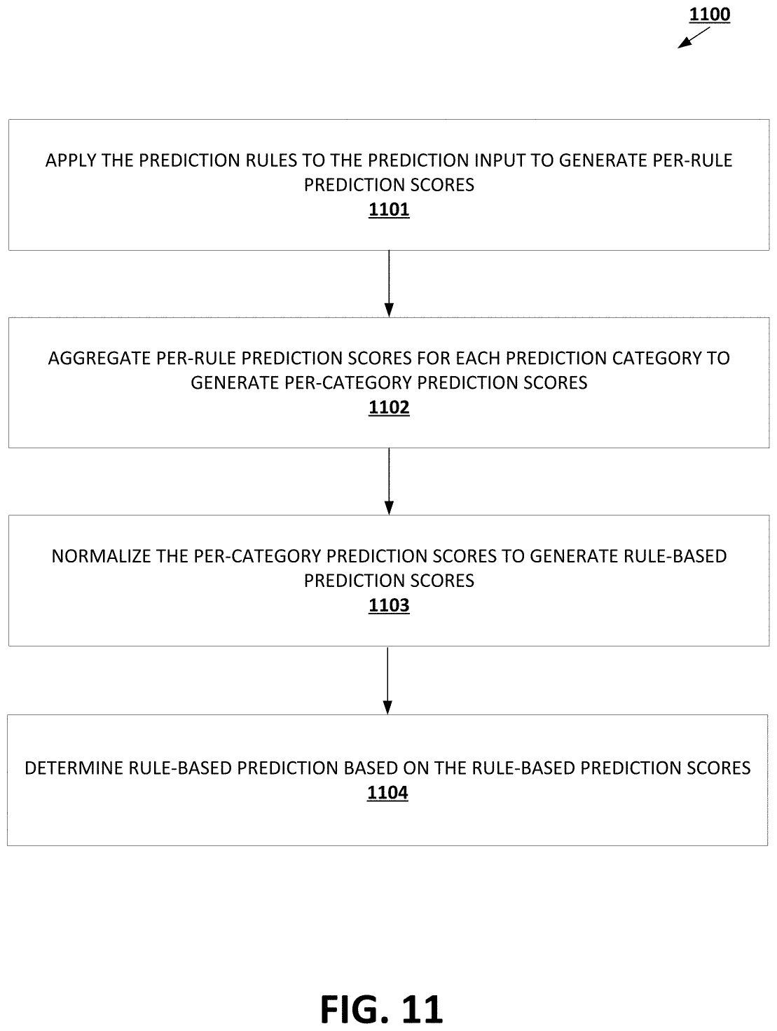

In some embodiments, step/operation 402 may be performed in accordance with various steps/operations of process 1100 depicted in FIG. 11. The process 1100 begins at step/operation 1101 when the rules engine 115 applies each prediction rule 502 to the prediction input 501 to generate a per-rule prediction score. For example, the rules engine 115 may apply the prediction rules 502 depicted in the prediction rules repository 900 of FIG. 9 to the prediction input 501 corresponding to the text prediction input 800 of FIG. 8. The prediction rules repository 900 includes, for example, prediction rule 901 whose satisfaction indicates that a prediction input 501 corresponds to a PGN (e.g., progress note) category with a confidence of +100, prediction rule 902 whose satisfaction indicates that a prediction input 501 corresponds to a CONS (e.g., counsel summary) category with a confidence of +15, and prediction rule 903 whose satisfaction indicates that a prediction input 501 corresponds to a DS (discharge summary) category with a confidence of −100 and a PGN category with a confidence of +15. In some embodiments, a user may define a prediction rule 502, e.g., by supplying at least one component of the prediction rule 502, such as the condition for the prediction rule 502 and/or one or more predictive weight values for the prediction rule 502.

Each prediction rule 502 may be a combination (e.g., a conjunction and/or disjunction) of one or more condition predicates, where each condition predicate may designate satisfy satisfactory values for a particular feature of the prediction input 501. In general, a prediction rule 502 designates a condition that a prediction input 501 may satisfy depending on one or more relevant features for the prediction input 501. For example, the prediction rules 502 depicted in the prediction rules repository 900 of FIG. 9 are based on presence of combinations of characters in a prediction input 501, as further described below.

For example, prediction rule 901 is satisfied when the prediction input 501 includes a combination of the following characters: “P” or “p,” followed by “r,” followed by “o” or “0,” followed by “gre,” and followed by “s” or “5” or “S” in a first word, and “N” or “n,” followed by “n,” followed by “o” or “0,” followed by “t” or “:e,” followed by “e” in a second word. As another example, prediction rule 902 is satisfied when the prediction input 501 includes a combination of the following characters: “C” or “G” or “c” or “ç,” followed by “o” or “0,” followed by “nsu,” followed by “lt” or “te,” optionally followed by “s” or “5” or “S,” and optionally followed by “:” or “;” or “i.” As yet another example, prediction rule 903 is satisfied when the prediction input includes a combination of the following characters: “E” or “e,” followed by “xpected” in a first word, and “D” or “O” or d,” followed by “l” or “I” or “;” “1,” followed by “s” or “5” or “S,” followed by “c” or “ç,” or followed by “har,” or followed by “g” or “9,” followed by, followed by “D” or “0,” followed by “ate,” followed by “:” or “;” or “I,” and optionally followed by “?.”

Importantly, the prediction rules depicted in the prediction rules repository 900 of FIG. 9 may capture features not captured by feature extraction at a time of training a machine learning model. For example, a prediction rule may capture embodiments of phrases when particular letters of those phrases may be distorted due to OCR-induced inaccuracies. For example, the training of a machine learning model might have failed to capture the phrase “Proge55 N0te” as corresponding to “Progress Note” because of the OCR-induced inaccuracy related to characters “S” and “o.” To counter that effect, a user (e.g., an SME) may supply a prediction rule (e.g., prediction rule 901) that captures “Proge55 N0te” and other OCR-induced inaccurate versions of the phrase “Progress Note” as features for the prediction system.

Returning to FIG. 11, at step/operation 1102, the rules engine 115 aggregates per-rule prediction scores for each prediction category to generate per-category prediction scores. For example, the rules engine 115 may aggregate (e.g., sum) all generated per-rule prediction scores for a first prediction category to generate a per-category prediction score for the first category; aggregate all generated per-rule prediction scores for a second prediction category to generate a per-category prediction score for the second category, and so on. As another example, if the prediction rules repository 900 of FIG. 9 is applied to a prediction input 501 and only prediction rules 901-903 are satisfied by the prediction input, the rules engine 115 may generate the following per-category prediction scores: for prediction category PGN, 100+15=115; for prediction category CONS, 15; and for prediction category DS, −100.

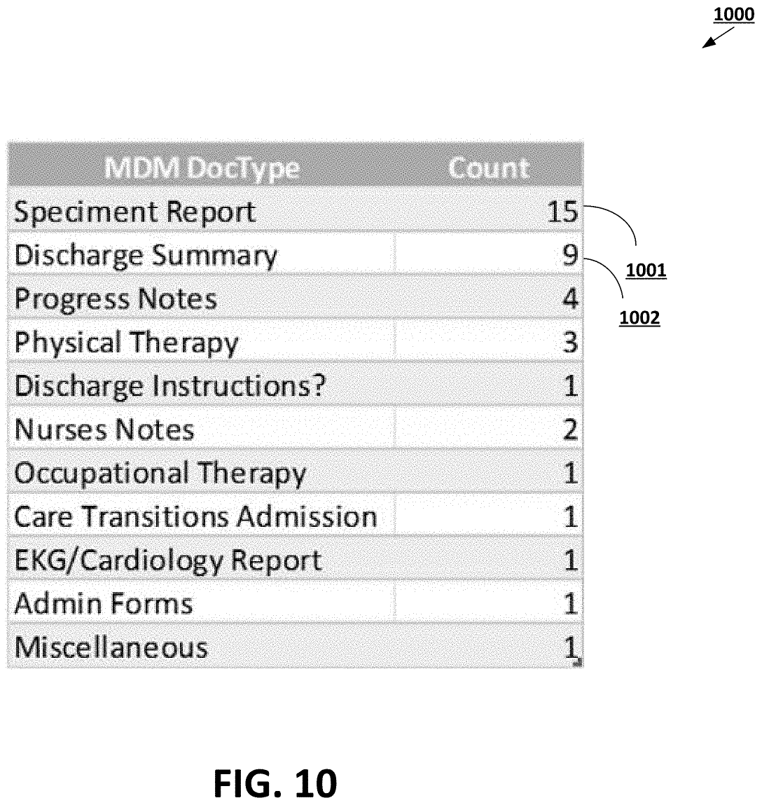

FIG. 10 provides an operational example of a per-category prediction score table 1000 that includes rule-based predictions for various prediction categories. For example, as depicted by entry 1001 in the per-category prediction score table 1000 of FIG. 10, the prediction category Specimen Report is associated with a per-category prediction score of 15. As another example, as depicted by entry 1002 in the per-category prediction score table 1000 of FIG. 10, the prediction category Discharge Summary is associated with a per-category prediction score of 9. This may indicate that the prediction category Specimen Report has a higher rule-based predictive correlation with the prediction input 501 relative to the prediction category Discharge Summary.

Returning to FIG. 11, at step/operation 1103, the rules engine 115 normalizes the per-category prediction scores to generate rule-based prediction scores. For example, the rules-engine may divide each per-category prediction score for a prediction input 501 by a sum of all per-category prediction scores for the prediction input 501. As another example, the rules engine 115 may use a softmax normalization function to normalize the per-category prediction scores and generate rule-based prediction scores. In some embodiments, the rules engine 115 may normalize the per-category prediction scores to a scale that is proportional (e.g., is the same as) the scale of the confidence values generated by the machine learning engine 117.

At step/operation 1104, the rules engine 115 determines a rule-based prediction based on the rule-based prediction scores. In some embodiments, the rules engine 115 may select the prediction category who has the highest corresponding rule-based prediction score as the rule-based prediction. In some other embodiments, the rules engine 115 may select the prediction category based on the rule-based prediction scores and in accordance with one or more prediction selection rules. In some embodiments, the rules engine 115 may determine that the prediction input 501 corresponds to a particular prediction category if the rule-based prediction score for the particular prediction category exceeds a threshold value. For example, the rules engine 115 may use a prediction selection rule that requires selection of a positive cancer prediction if the rule-based prediction score for the positive cancer prediction exceeds a threshold value (e.g., 0.10).

Returning to FIG. 4, at step/operation 403, the prediction computing entity 106 processes the prediction input 501, the rule-based prediction scores 513, and the rule-based prediction 512 using the machine learning engine 117 to generate a machine learning prediction output. Each of the prediction input 501, the rule-based prediction scores 513, and the rule-based prediction 512 may be processed by any machine learning node in any machine learning layer of the machine learning engine 117. One technological objective of this step/operation is to integrate at least a portion of the rules engine output 504 (e.g. at least a portion of the rule-based prediction scores 513 and/or at least a portion of the rule-based prediction 512) into the machine learning engine 117. Accordingly, a person of ordinary skill in the art will recognize that there are various ways of accomplishing this technological objective.

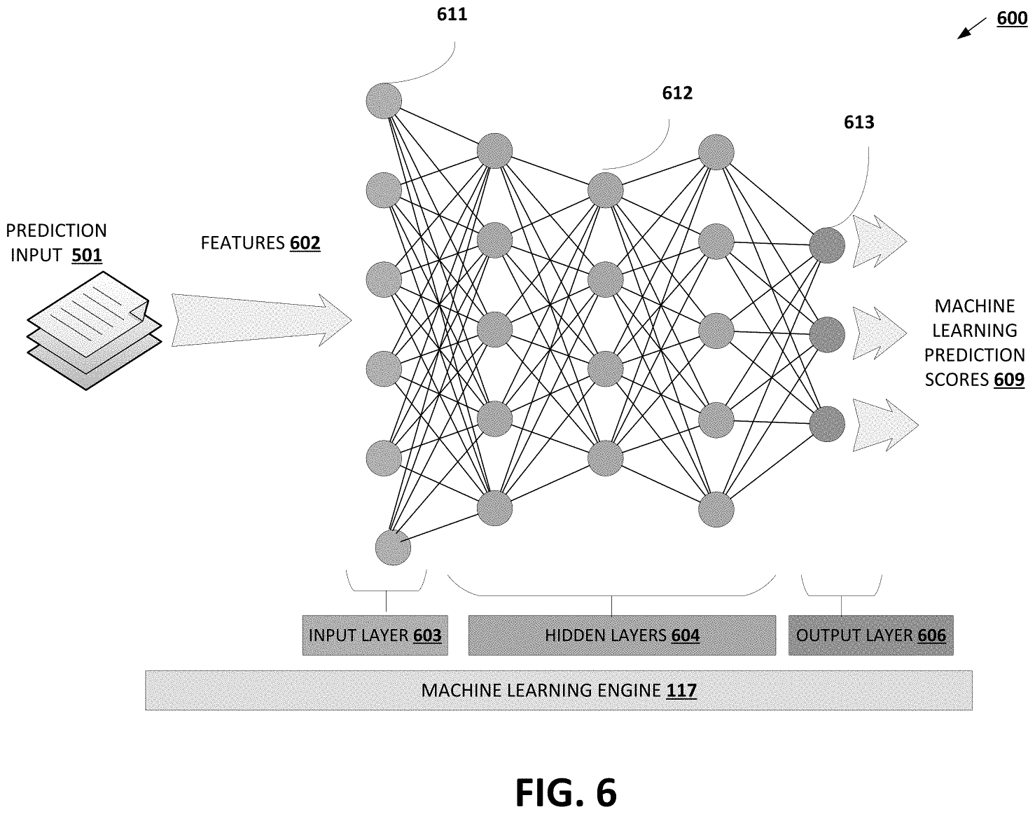

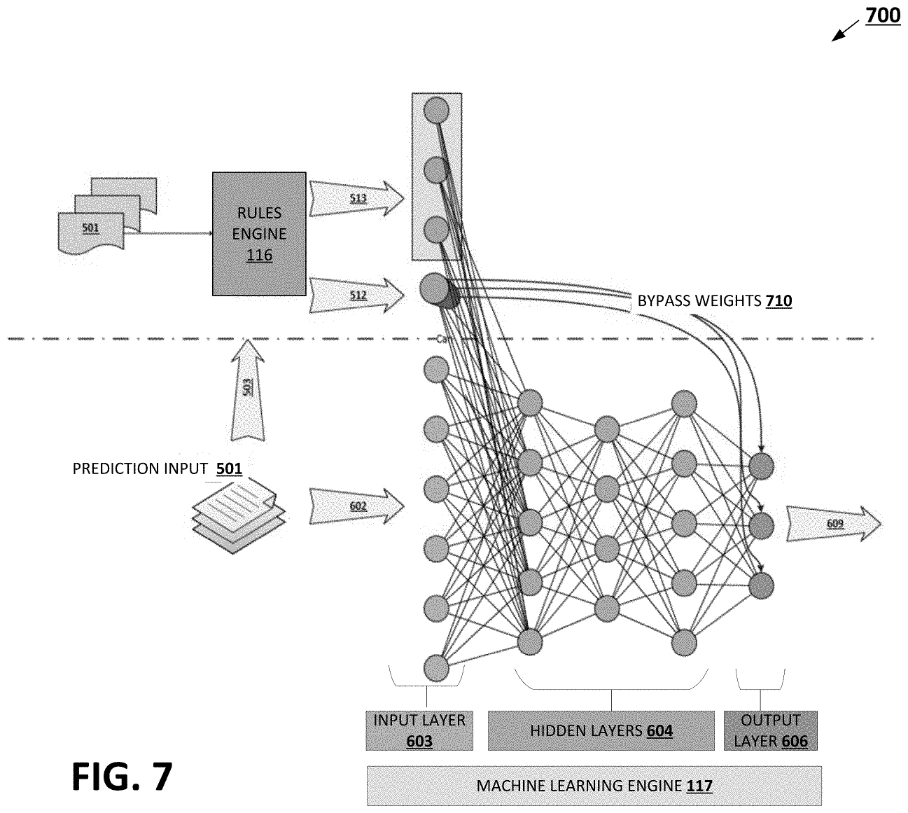

For example, in some embodiments, step/operation 403 may be performed in accordance with the various steps/operations of process 700 of FIG. 7. The process 700 includes steps/operations performed by the rules-engine 115 as depicted in process 500 of FIG. 5 as well as steps/operations performed by the machine learning engine 117, an example of which is presented in process 600 of FIG. 6. While the process 600 of FIG. 6 includes a machine learning engine 117 utilizing an artificial neural network having a fully-connected structure, a person of ordinary skill in the art will recognize that the machine learning engine 117 may utilize other machine learning structures, such as non-fully-connected artificial neural networks (e.g., a convolutional neural network, a recurrent neural network, an auto-encoder, a neural Turing machine, etc.) and/or machine learning frameworks that do not utilize artificial neural networks (e.g., Bayesian belief networks, regression engines, random forest engines, genetic predictive networks, support vector machines, etc.). In general, the machine learning engine 117 may utilize one or more machine learning units having different structures, utilizing different numerical operations, and/or trained using different training algorithms.

The process 600 of FIG. 6 begins when the machine learning engine 117 extracts a set of machine learning features 602 from the prediction input 501. For example, if the prediction input 501 is a text input, the set of machine learning features may be a vector of one or more words of the text input. As another example, if the prediction input 501 is a text input, the set of machine learning features may be a vector that indicates frequency of occurrence of one or more index phrases in the text input. As yet another example, if the prediction input is a visual data item, the set of machine learning features may be a vector that includes various measurements of the visual data item. The machine learning engine 117 then provides the set of machine learning features 602 as an input to various machine learning nodes of an input layer 603 of the artificial neural network of the machine learning engine 117. For example, if the set of machine learning features 602 include n machine learning features, the machine learning engine 117 may provide each feature to one of n machine learning nodes of the input layer 603.

Importantly, the format of the set of machine learning features 602 may be defined during training by the training engine 116 and may be difficult or impossible to change afterward. For example, if a machine learning model is trained by the training engine 116 to process a vector of n features [f₁, f₂, . . . fₙ], it may be difficult or impossible for the machine learning engine 117 to use the machine learning model to generate classifications for a feature vector [f₁, f₂, . . . fₙ₋₁] or a feature vector [f₁, f₂, . . . fₙ₊₁]. For example, the machine learning model may lack machine learning parameter values for machine learning features not integrated into the machine learning model during training. As another example, some particular machine learning parameter values for the machine learning model may have been set during training with a particular understanding of the structure of the machine learning model including application of other machine learning parameter values as part of applying the machine learning model, rendering the machine learning model impractical or ineffective when presented with prediction inputs 501 that miss expected feature values and thus fail to apply the totality of the trained machine learning model. Thus, the set of machine learning features 602 may be smaller than set of all relevant features of the prediction input 501 and/or may be smaller than set of all features of the prediction input 501 captured through application of the prediction rules 502.

For example, referring to prediction rule 901 of FIG. 9, the set of machine learning features 602 may include a feature that indicates presence and/or frequency of the term “Progress Note” in the prediction input 501, but may otherwise lack a feature that indicates presence and/or frequency of various deviations of the term “Progress Note,” including deviations resulting from spelling error and/or OCR-generated errors (e.g., pr0gre5 N0t:e). On the other hand, unlike the set of machine learning features 602, the prediction rules 502 can be defined and/or modified after training in order to capture newly discovered and/or previously ignored features of the prediction input 501. Accordingly, various prediction rules depicted in the prediction rules repository 900 of FIG. 9 capture deviations of the target terms, such as deviations resulting from OCR-generated errors.

Returning to FIG. 6, the artificial neural network of the machine learning engine 117 includes various layers, including an input layer 603, one or more hidden layers 604, and an output layer 606. While the exemplary machine learning engine 117 of FIG. 6 includes three hidden layers, a person of ordinary skill in the art will recognize that there may be various layers. Each machine learning layer may include one or more machine learning nodes, such as node 611 in the input layer 603, node 612 in the second layer of the hidden layers 604, and node 613 in the output layer 606. Moreover, while each machine learning node of the depicted artificial neural network in FIG. 6 provides an output to each machine learning node in a subsequent layer of the artificial neural network, a person of ordinary skill in the art will recognize that each machine learning node may provide features to any one or more machine learning nodes in the artificial neural network, including to some but not all of the machine learning nodes in a subsequent layer of the artificial neural network.

Each machine learning node of the artificial neural network may be configured to receive one or more input values, process the one or more input values in accordance with one or more parameters to generate an output value, and provide the output value to (for all machine learning nodes other than the machine learning nodes of output layer 606) one or more machine learning nodes in a subsequent machine learning layer of the artificial neural network or (for all machine learning nodes in the output layer 606) as one or more machine learning prediction scores 609 (e.g., one or more confidence values generated by the machine learning model) that can define and/or characterize a classification generated by the artificial neural network. For example, each machine learning node may process each input value in accordance with a weight value for the particular input to generate a weighted, aggregate the weighted inputs to generate an activation value, apply a non-linear function to the activation value to generate an initial output value, and apply a bias to the initial output value to generate a final output value.

Returning to FIG. 7, to integrate the rules engine 115 with the machine learning engine 117, various steps/operations of process 700 may be performed. The process 600 may include providing the rule-based prediction scores 513 generated by the rules engine 115 to a machine learning node of a the artificial neural network other than the machine learning nodes in the output layer 606, for example providing each rule-based prediction scores to each machine learning node in a first layer of the hidden layers 604 of the artificial network. Moreover, the process 600 may include providing the rule-based prediction 512 to at least one machine learning node of the output layer 606 of the artificial neural network and/or to a classification-generation component of the machine learning engine 117 (not depicted) configured to generate a classification based on the machine learning prediction scores 609 generated by the machine learning nodes in the output layer 606 of the artificial neural network. For example, the process 600 may include providing the rule-based prediction 512 to each machine learning node in the output layer 606. In some embodiments, before providing the rule-based prediction 512 to a machine learning node of the output layer 606, the machine learning engine 117 applies one or more bypass weights 710 to the rule-based prediction 512. In some embodiments, the bypass weight(s) 710 for each machine learning node of the output layer 606 may be determined during training, using a training algorithm such as gradient descent.

In some embodiments, integrating rule-based prediction scores 513 into the machine learning engine 117 enables the machine learning engine 117 to have dynamically-defined inputs, e.g., inputs whose underlying generative computational models may change after training, in addition to statistically-defined inputs, e.g., inputs whose underlying generative computational may not change after training. In other words, the training engine 116 may train the machine learning engine 117 with a variable that is configured to incorporate evolutions in structure of training data. In doing so, the training engine 116 may train more robust machine learning models and enable integration of post-training discoveries into machine learning models.

In some embodiments, integrating the rule-based prediction 512 into generating a classification by the machine learning engine 117 enables the machine learning engine 117 to incorporate post-training discoveries and conclusions into a final classification conclusions. For example, the machine learning engine 117 may conclude based on a rule-based prediction 512 with a high confidence that the rule-based prediction 512 should be adapted over a classification generated by the machine learning system. As another example, the machine learning engine 117 may generate a prediction output based on a combination of a machine learning classification and a rule-based prediction 512. In an exemplary embodiment, the machine learning engine 117 may conclude, based on a machine learning classification of a prediction input 501 as being sports-related and a rule-based prediction 512 of the prediction input 501 as being news-related, that the prediction input 501 is related to sports news. As yet another example, the machine learning engine 117 may provide both the machine learning classification and the rule-based prediction 512 to the user.

In some embodiments, deploying a process that integrates a rules engine 115 and a machine learning engine 117 (e.g., the process 800 of FIG. 8) includes deploying the rules database 123 on the storage system 108, deploying the rules engine 115 on the prediction computing entity 106, deploying the machine learning model on the parameters database 122, and deploying machine learning engine 117 on the prediction computing entity 106. In some embodiments, during a predictive inference performed to generate a classification for a prediction input, the machine learning engine 117 retrieves the machine learning model, deserializes the machine learning model, retrieves prediction rules including their respective predictive weights, generates rule-based prediction scores and the rule-based prediction, and utilizes the rule-based prediction scores and the rule-based prediction to generate a final prediction output.

In some embodiments, the prediction system 101 generates, based on user input, prediction rules that correspond to a plurality of prediction categories (which may include at least some of the prediction categories associated with a machine learning model stored in the parameters database 122), uses the training engine 116 to train the machine learning model, and enables user to supply prediction rules and/or modify prediction rules after training based on the user's requirements and objectives.

### E. Training Hybrid Rule-Based Machine-Learning Predictive Solutions

Hybrid rule-based machine-learning solutions, such as various solutions described above, can be trained using any training algorithm that generates a machine learning model configured to generate predictive outputs using predictive data provided by the rules engine 115 (e.g., by at least one of one or more rule-based prediction scores and a rule-based prediction score). Importantly, in some embodiments, the training engine 116 may use a different training algorithm for determining parameters related to dynamically-defined input data (e.g., predictive data provided by the rules engine 115) relative to the training algorithm used for determining parameters related to statistically-defined input data.

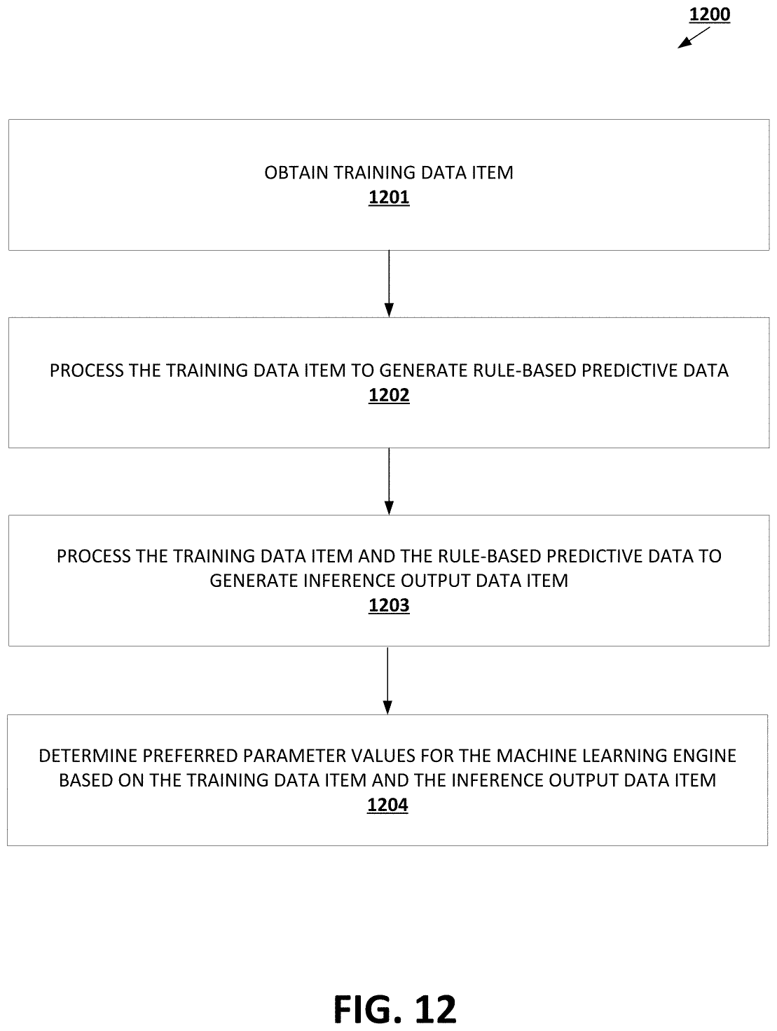

FIG. 12 depicts a flowchart diagram of an example process 1200 for training a machine learning engine to generate predictive outputs by integrating rule-based predictive data. The various steps/operations of process 1200 may be performed by a system of one or more computers, e.g., the prediction system 101 of FIG. 1. Via the various steps/operations of FIG. 4, the prediction system 101 can train a predictive system that integrates rule-based predictions in a machine learning predictive framework.

The process 1200 begins at step/operation 1201 when the training engine 116 obtains a training data item, e.g., retrieves the training data item from the training database 121. The training data item may include a training input portion and a target output portion. The training input portion may include one or more machine-learning training features for the training data item and one or more rule-based training features for the training data item. The machine-learning training features for the training data item may include features of the training data item that correspond to one or more expected inputs of the machine learning engine 117. The rule-based training features for the training data item may include features of the training data item that correspond to one or more expected inputs of the rules engine 115. In some embodiments, the machine learning training features and the rule-based training features may include the same features.

At step/operation 1202, the rules engine 115 processes the training data item to generate the rule-based predictive data. For example, the rules engine 115 may obtain at least a portion of the training data item (e.g., the rule-based training features) from the training engine 116, retrieve one or more relevant prediction rules from the rules database 123, and process the at least a portion of the training data item to generate the rule-based predictive data. The rule-based predictive data may include at least one output of the rules engine 115, e.g., including at least one output of the rules engine 115 that is associated with a trainable parameter for the machine learning engine 117. For example, in the predictive system depicted in the data flow diagram of FIG. 7, the rule-based predictive data generated by the rules engine 115 may include rule-based prediction scores 513 provided to each machine learning node in a first layer of the hidden layers 604 of the machine learning engine 117. As another example, again in the predictive system depicted in the data flow diagram of FIG. 7, the rule-based predictive data may further include a rule-based prediction score 513 provided to each machine learning node in an output layer 606 of the machine learning engine 117 since the machine learning engine 117 utilizes bypass weight 710 to modify the rule-based prediction score 513 provided to each machine learning node in the output layer. In some embodiments, the rules engine 115 provides the rule-based predictive data to the training engine 116 for further processing by the training engine 116 as part of the training process.

At step/operation 1203, the machine learning engine 117 processes the training data item and the rule-based predictive data to generate an inference output data item for the training data item. For example, the machine learning engine 117 may obtain at least a portion of the training data item (e.g., the machine-learning training features) from the training engine 116, obtain the rule-based predictive data from the training engine 116 and/or from the rules engine 115, retrieve a machine learning model from the parameters database 122, and process the at least a portion of the training data item and the rule-based predictive data in accordance with the machine learning model to generate an inference output data item. In some embodiments, the machine learning engine 117 processes the at least a portion of the training data item and the rule-based predictive data in accordance with the machine learning model using a forward propagation algorithm. In some embodiments, the machine learning engine 117 provides the inference output data item for the training data item.

At step/operation 1204, the training engine 116 determines one or more preferred parameter values for one or more parameters of the machine learning engine 117 based on the training data item and the inference output data item for the training data item. For example, the machine learning engine 117 may determine a utility function that maps possible values for the one or more parameter values of the machine learning engine 117 to a measure of difference between the target output portion of the training data item and the inference output data item for the training data item. The machine learning engine 117 may then (using an optimization algorithm such as gradient descent) select values for the one or more parameter values of the machine learning engine 117 that optimize the utility function (e.g., minimize an error utility function and/or maximize a reward utility function). The machine learning engine 117 may then determine the one or more preferred parameter values based on the one or more selected parameter values, e.g., the values for the one or more parameter values of the machine learning engine 117 that optimize the utility function.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving a prediction input;
generating a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score;
determining a rule-based prediction output based at least in part on the plurality of rule-based prediction scores; and
providing the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

2. The computer-implemented method of claim 1, wherein a prediction system comprises the machine learning engine.

3. The computer-implemented method of claim 1, wherein:
the machine learning engine comprises a neural network having one or more input layers, one or more hidden layers, and one or more output layers,
a first hidden layer of the one or more hidden layers comprises one or more first hidden nodes, and
providing the plurality of rule-based prediction scores to the machine learning engine comprises providing the plurality of rule-based prediction scores to a first plurality of nodes of the one or more first hidden nodes.

4. The computer-implemented method of claim 1, wherein:
the machine learning engine comprises a neural network having one or more input layers, one or more hidden layers, and one or more output layers,
the one or more output layers comprises one or more output nodes, and
providing the rule-based prediction output to the machine learning engine comprises providing the rule-based prediction output to at least one output machine learning node of the one or more output machine learning nodes.
providing the rule-based prediction output to the machine learning engine comprises providing the rule-based prediction output to at least one output node of the one or more output nodes.

5. The computer-implemented method of claim 1, wherein generating the plurality of rule-based prediction scores further comprises:
determining, based at least in part on one or more satisfied predictive weights, a plurality of adjusted rule-based prediction scores; and
normalizing the plurality of adjusted rule-based prediction scores to generate a plurality of normalized prediction scores.

6. The computer-implemented method of claim 6 further comprising (a) determining one or more rule-based features for the prediction input, and (b) determining one or more machine learning features for the prediction input.

7. The computer-implemented method of claim 6, wherein the one more rule-based features comprise at least one feature different than the one or more machine learning features.

8. The computer-implemented method of claim 1, wherein generating the plurality of rule-based prediction scores further comprises:
determining, by the rules engine, the plurality of rule-based prediction scores based at least in part on one or more satisfied predictive weights, wherein each satisfied predictive weight of the one or more satisfied predictive weights is associated with a satisfied prediction rule of the one or more prediction rules, and wherein each satisfied prediction rule is a prediction rule of the one or more prediction rules whose respective rule condition is satisfied by the prediction input.

9. The computer-implemented method of claim 8, wherein determining the plurality of rule-based prediction scores based at least in part on one or more satisfied predictive weights comprises:
for each prediction category of a plurality of prediction categories, determine a rule-based prediction score of the plurality of rule-based prediction scores for the prediction category based at least in part an aggregate of each satisfied predictive weight of the one or more satisfied predictive weights that is associated with the prediction category.

10. The computer-implemented method of claim 1, wherein at least a first prediction rule of the one or more prediction rules is determined based on data provided by a subject-matter-expert user.

11. A prediction system comprising at least one processor and at least one memory comprising program code, the at least one memory and the program code configured to, with the processor, cause the prediction system to at least:
receive a prediction input;
generate a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score;
determine a rule-based prediction output based at least in part on the plurality of rule-based prediction scores; and
provide the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

12. The prediction system of claim 11, wherein the prediction system comprises the machine learning engine.

13. The prediction system of claim 11, wherein:
the machine learning engine comprises a neural network having one or more input layers, one or more hidden layers, and one or more output layers,
a first hidden layer of the one or more hidden layers comprises one or more first hidden nodes, and
providing the plurality of rule-based prediction scores to the machine learning engine comprises providing the plurality of rule-based prediction scores to a first plurality of nodes of the one or more first hidden nodes.

14. The prediction system of claim 11, wherein:
the machine learning engine comprises a neural network having one or more input layers, one or more hidden layers, and one or more output layers,
the one or more output layers comprises one or more output nodes, and
providing the rule-based prediction output to the machine learning engine comprises providing the rule-based prediction output to at least one output machine learning node of the one or more output machine learning nodes.
providing the rule-based prediction output to the machine learning engine comprises providing the rule-based prediction output to at least one output node of the one or more output nodes.

15. The prediction system of claim 11, wherein generating the plurality of rule-based prediction scores further comprises:
determining, based at least in part on one or more satisfied predictive weights, a plurality of adjusted rule-based prediction scores; and
normalizing the plurality of adjusted rule-based prediction scores to generate a plurality of normalized prediction scores.

16. The prediction system of claim 11, further configured to (a) determine one or more rule-based features for the prediction input, and (b) determine one or more machine learning features for the prediction input.

17. The prediction system of claim 16, wherein the one more rule-based features comprise at least one feature different than the one or more machine learning features.

18. A computer program product comprising at least one non-transitory computer-readable storage medium having computer-readable program code portions stored therein, the computer-readable program code portions, when executed, cause a prediction system to:
receive a prediction input;
generate a plurality of rule-based prediction scores by executing one or more prediction rules on the prediction input, wherein (a) each prediction rule of the one or more prediction rules is associated with a rule condition and one or more predictive weights, (b) each predictive weight of the one or more predictive weights is associated with a related prediction category of a plurality of prediction categories, and (c) each prediction category of the plurality of prediction categories is associated with a rule-based prediction score;
determine a rule-based prediction output based at least in part on the plurality of rule-based prediction scores; and
provide the plurality of rule-based prediction scores and the rule-based prediction output to a machine learning engine, wherein the machine learning engine is configured to generate a machine-learning based prediction output based at least in part on the plurality of rule-based prediction scores and the rule-based prediction output.

19. The computer program product of claim 18, wherein the prediction system comprises the machine learning engine.

20. The computer program product of claim 18, wherein:
the machine learning engine comprises a neural network having one or more input layers, one or more hidden layers, and one or more output layers,
a first hidden layer of the one or more hidden layers comprises one or more first hidden nodes, and
providing the plurality of rule-based prediction scores to the machine learning engine comprises providing the plurality of rule-based prediction scores to a first plurality of nodes of the one or more first hidden nodes.
